(19) United States
(12) Patent Application Publication
(10) Pub. No.: US 2017/0307224 A1
(43) Pub. Date: Oct. 26, 2017

(54) Method For Performing A Treatment By A Domestic Appliance And For Processing Information Of Said Treatment By A Mobile Computer Device

(71) Applicant: Electrolux Appliances Aktiebolag, Stockholm (SE)

(72) Inventors: Alex VIROLI, Forli (IT); Massimo NOSTRO, Forli (IT); Filippo MARTINI, Forli (IT); Laurent JEANNETEAU, Forli (IT)

(21) Appl. No.: 15/515,919

(22) PCT Filed: Nov. 26, 2015
(86) PCT No.: PCT/EP2015/077746

§ 371 Date: Mar. 30, 2017

(30) Foreign Application Priority Data
Dec. 3, 2014 (EP) EP14195988.2

(51) Int. Cl. F24C 7/08; A47L 15/00; D06F 39/00; H05B 6/64

(52) U.S. Cl. CPC F24C 7/085; H05B 6/6441; A47L 15/0018; D06F 39/005

(57) ABSTRACT

A method for performing a treatment by a domestic appliance having a programmable control unit and a graphic display. The method includes executing a program for performing the treatment, encoding information about the appliance, the program and/or a current status of the appliance, generating a two-dimensional code representing the encoded information, and displaying the code on the graphic display, so that the code is detectable by a camera or scanner of a mobile computer device. Further, a method for processing information about a treatment performed by a domestic appliance, wherein the information is encoded by a two-dimensional code on a graphic display of the appliance. The method includes detecting the two-dimensional code by a camera or scanner, decoding the code, and indicating the decoded information on a display, and/or transmitting the decoded information to a computer device via the internet, and/or processing the decoded information by an application software.

The present invention relates to a method for performing a treatment by a domestic appliance, wherein the domestic appliance includes at least one programmable control unit and at least one graphic display device. Further, the present invention relates to a method for processing information about a treatment by a domestic appliance, wherein said information is encoded by a two-dimensional code indicated by a graphic display of the domestic appliance. Moreover, the present invention relates to application software for a mobile computer device including a camera or scanner. Additionally, the present invention relates to a domestic appliance comprising at least one programmable control unit and at least one graphic display, wherein the control unit is provided for encoding information about the domestic appliance, the program for performing the treatment and/or a current status of the domestic appliance, and wherein the graphic display is provided for indicating a two-dimensional code representing said encoded information. Furthermore, the present invention relates to a mobile computer device connected or connectable to the internet and including a camera or scanner for detecting and decoding a two-dimensional code indicated by a graphic display of the domestic appliance.

Modern domestic appliances comprise user interfaces including one or more graphic displays with high resolution. Said graphic displays usually indicate information about the domestic appliance or the treatment process performed by said domestic appliance. Thus, the user may be informed about the treatment process and/or further details of the domestic appliance.

Further, the applications of mobile computer devices increase. The mobile computer devices include one or more camera on the one hand and an internet connection on the other hand. Moreover, the mobile computer device is able to download application software.

It is an object of the present invention to provide an improved method for performing a treatment by a domestic appliance and for processing information about said treatment by a mobile computer device.

The object is achieved by the method according to claim 1.

The present invention relates to the method for performing a treatment by a domestic appliance, wherein the domestic appliance includes at least one programmable control unit and at least one graphic display device, and wherein the method comprises the steps of:
providing a program for performing the treatment,
executing the program for performing the treatment,
encoding information about the domestic appliance, the program for performing the treatment and/or a current status of the domestic appliance,
generating a two-dimensional code representing the encoded information about the domestic appliance, the program for performing the treatment and/or the current status of the domestic appliance, and
displaying said two-dimensional code on the graphic display, so that
the two-dimensional code is detectable by a camera or scanner of a mobile computer device.

The core of the present invention is the indication of information by the two-dimensional code on the graphic display. Said information may relate to general properties of the domestic appliance as well as to individual features defined by the user. The information may be detected by a usual mobile computer device.

Further, the object of the present invention is achieved by the method according to claim 2.

Additionally, the present invention relates to the method for processing information about a treatment performed by a domestic appliance, wherein said information is encoded by a two-dimensional code indicated by a graphic display of the domestic appliance, and wherein the method comprises the steps of:
detecting the two-dimensional code by a camera or scanner of a mobile computer device,
decoding the two-dimensional code, and
indicating the decoded information on a display of the mobile computer device, and/or
transmitting the decoded information to a further computer device via the internet, and/or
processing the decoded information by an application software on the mobile computer device and/or on the further computer device.

The mobile computer device may detect and process the information represented by the two-dimensional code by low complexity. The camera or scanner and a microprocessor are standard features of a present mobile computer device.

The method for performing the treatment by the domestic appliance mentioned above and the method for processing information about the treatment performed by the domestic appliance may be combined to one single method. Factually, said single method is substantially performed by the domestic appliance and supported by the mobile computer device.

For example, the two-dimensional code includes information about at least one fault of the domestic appliance, if the control unit of the domestic appliance has detected said at least one fault. The information about the fault may be transferred to a repair service centre via the internet.

Furthermore, the two-dimensional code may include information about a predetermined number of the last faults of the domestic appliance, so that a fault history for the domestic appliance is provided.

According to another example, the two-dimensional code may provide information about the complete operating duration of the domestic appliance since said domestic appliance has been installed. This information may identify the use of the domestic appliance in an improper way, e.g. as a professional appliance. The use in the improper way would invalidate the warranty.

Preferably, the two-dimensional code provides information about a link to the homepage of the producer and/or distributor of the domestic appliance.

According to a preferred embodiment of the present invention, the treatment is a cooking process performed by a cooking appliance, wherein a cooking recipe and/or program for the cooking process are encoded by the two-dimensional code.

In particular, the cooking recipe and/or program for said cooking process may be created or creatable by the user.

Further, the cooking recipe and/or program for the cooking process may be decoded by the mobile computer device and transmitted to a social network via the internet.

Moreover, the two-dimensional code may include information for activating the warranty the domestic appliance, wherein said information is decoded by the mobile computer device and transmitted to the producer and/or distributor of the domestic appliance via the internet.

Additionally, the present invention relates to application software for the mobile computer device, wherein the application software is provided for performing the method mentioned above.

For example, the application software may be provided by the producer and/or distributor of the domestic appliance and downloadable via the internet.

Moreover, the present invention relates to a domestic appliance comprising at least one programmable control unit and at least one graphic display, wherein the control unit is provided for encoding information about the domestic appliance, the program for performing the treatment and/or a current status of the domestic appliance, and wherein the graphic display is provided for indicating a two-dimensional code representing said encoded information, wherein the domestic appliance is provided for the method mentioned above.

Furthermore, the present invention relates to a mobile computer device connected or connectable to the internet and including a camera or scanner for detecting and decoding a two-dimensional code indicated by a graphic display, wherein the mobile computer device is provided for the method mentioned above and/or the mobile computer device supports the aforesaid application software.

At last, the present invention relates to a computer program stored in a computer usable medium, comprising computer readable program means for causing a computer to perform the method mentioned above, wherein the computer program includes the aforesaid application software.

Novel and inventive features of the present invention are set forth in the appended claims.

The present invention will be described in further detail with reference to the drawings, in which

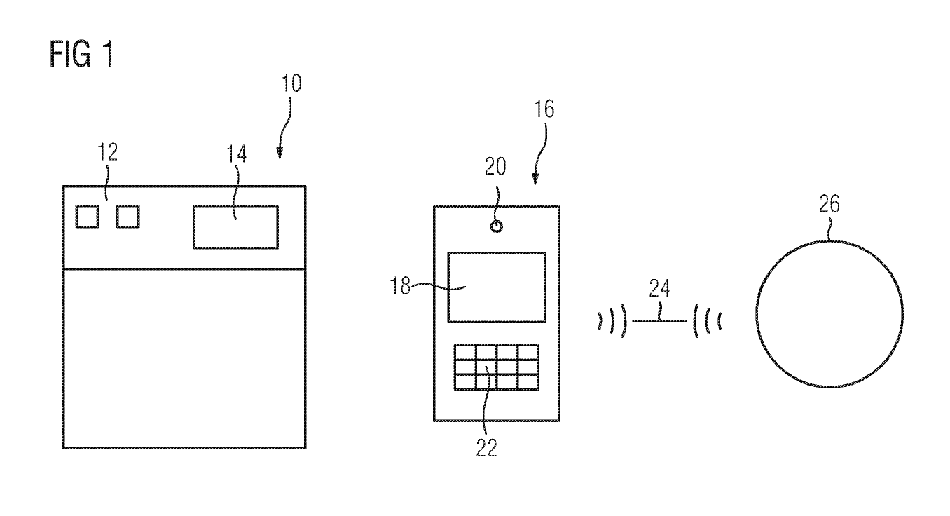

FIG. 1 illustrates a schematic view of a domestic appliance and a mobile computer device according to a preferred embodiment of the present invention, and

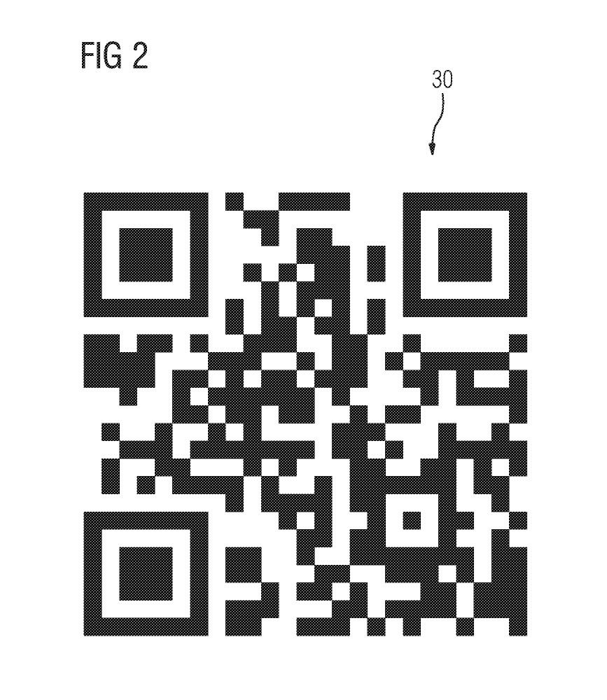

FIG. 2 illustrates an example of a graphic representation of a two-dimensional code related to data of and/or information about the domestic appliance according to the preferred embodiment of the present invention.

FIG. 1 illustrates a schematic view of a domestic appliance 10 and a mobile computer device 16 according to a preferred embodiment of the present invention. For example, the domestic appliance 10 may be a cooking oven, a microwave oven, a dishwasher, a washing machine or a tumble dryer. In general, the domestic appliance 10 is an arbitrary appliance, whose operation is supported or supportable by the mobile computer device 16 in any way.

The domestic appliance 10 comprises a user interface 12 including operating elements and a graphic display 14. In this example, the graphic display 14 is a high definition colour graphic display. In general, the graphic display 14 has a resolution sufficient for representing a two-dimensional code. The expression “two-dimensional code” relates to the geometric structure of the representation of said code, but not to the encoding itself. For example, a barcode is represented by a two-dimensional image, while its encoding is one-dimensional. In contrast, a quick response (QR) code or a stacked barcode is represented by a two-dimensional image in each case, wherein their encodings are also two-dimensional.

Further, the domestic appliance 10 comprises a control unit, which is not explicitly shown in FIG. 1. The control unit provides information about the domestic appliance 10. For example, the control unit provides information about a current status of a treatment process performed by the domestic appliance 10. Further, the control unit may provide information about a program for controlling the treatment process performed by the domestic appliance 10. The information is encoded by the control unit and represented by the display 14 as two-dimensional code.

The mobile computer device 16 comprises a display 18, a camera 20 and a keyboard 22. The display 18 forms an output unit of the mobile computer device 16, while the keyboard 22 forms an input unit of the mobile computer device 16. Additionally or instead of the display 18 and/or the keyboard 22, the mobile computer device 16 may comprise a touchscreen. The touch screen may form an input/output unit of the mobile computer device 16. If the display 18 is formed as the touch screen, then the mobile computer device 12 does not need necessarily the keyboard 22. Additionally or instead of the camera 20, the mobile computer device 16 may comprise a scanner.

The mobile computer device 16 may be a customary device. For example, the mobile computer device 16 may be a mobile phone, a smart phone, a tablet personal computer, a netbook or a notes book.

The camera 20 or scanner of the mobile computer device 16 is provided for detecting or scanning, respectively, the two-dimensional code represented by the graphic display 14 of the domestic appliance 10. Thus, the graphic display 14 of the domestic appliance 10 and the camera 20 of the mobile computer device 16 form an optical interface system for transmitting data and/or information from the domestic appliance 10 to the mobile computer device 16.

Optionally, there is a wireless connection 24 between the mobile computer device 16 and the internet 26. Preferably, the mobile computer device 16 is connected to the internet 28 via a wireless local area network (WLAN) or the mobile communications network. The wireless connection 24 allows communications between the mobile computer device 16 and the internet 26. In particular, the mobile computer device 16 may use applications provided by the internet 26. Further, the user is able to download data or software for the mobile computer device 16 from the internet 26. For example, the user may download application software (“APP”) for the mobile computer device 16 from the internet 26. Preferably, said application software relates to the domestic appliance 10. Moreover, the user can access to data bases in the internet 26 by the mobile computer device 16. In particular, said data bases are provided by the producer of the domestic appliance 10.

FIG. 2 illustrates an example of a graphic representation of a two-dimensional code 30 related to data of and/or information about the domestic appliance 10 according to the preferred embodiment of the present invention. In this example, the two-dimensional code 30 is a QR (quick response) code. Further, the two-dimensional code may be a barcode or a stacked barcode.

The two-dimensional code 30 is represented by the graphic display 14 of the domestic appliance 10. The two-dimensional code 30 includes information about the domestic appliance 10, the status of said domestic appliance 10 and/or the program for controlling said domestic appliance 10. The user is able to photograph or scan the two-dimensional code 30 by the camera 20 or scanner, respectively, of the mobile computer device 16. The mobile computer device 16 decodes the information of the two-dimensional code 30. For example, the mobile computer device 16 retrieves a uniform resource locator (URL) of the internet.

An application of the two-dimensional code 30 is fault recognition. When the domestic appliance 10 detects a fault, then the control unit of the domestic appliance 10 generates a two-dimensional code 30 defining exactly said fault. The mobile computer device 16 transfers the information about the fault to a repair service centre via the internet. Then the repair service centre knows immediately the status of the domestic appliance 10. The repair service centre may inform the user about the details of the fault and/or how to repair the domestic appliance 10. The repair service centre and/or the user may order a mobile repair service.

Further, the two-dimensional code 30 may provide information about the last faults of the domestic appliance 10. Thus, the two-dimensional code 30 includes a fault history. For example, the last five or the last ten faults of the domestic appliance 10 are encoded within the two-dimensional code 30. The fault history of the domestic appliance 10 may be detected by the mobile computer device 16 and transferred to the repair service centre via the internet.

Another application of the two-dimensional code 30 may be the registration and/or activation of the warranty of the domestic appliance 10. After the user has purchased the domestic appliance 10, its warranty is registered and/or activated by detecting the two-dimensional code 30 by the mobile computer device 16 and transferring corresponding data to the producer or distributor via the internet.

If the domestic appliance 10 is a cooking appliance, then a cooking recipe created by the user may be encoded by the control unit of said domestic appliance 10. In this case, the two-dimensional code 30 includes said cooking recipe. The cooking recipe may be detected by the mobile computer device 16 and shared in a social network via the internet.

Moreover, the two-dimensional code 30 may provide information about the complete operating duration of the domestic appliance 10 since it has been installed. For example, this information may identify that the domestic appliance 10 has been used in an improper way, e.g. as a professional appliance. The use of the domestic appliance 10 in the improper way would invalidate the warranty.

Further, the two-dimensional code 30 may provide a link to the homepage of the producer of the domestic appliance 10, so that the user may download application software and/or information on the mobile computer device 16. If the domestic appliance 10 is a cooking appliance, then the user could download cooking recipes proposed by the producer of said cooking appliance.

In general, the domestic appliance 10 may be an arbitrary device like a cooking appliance, a washing machine, a tumble dryer or a dishwasher. For example, the user may create a program for treating special clothes by the washing machine and/or tumble dryer, so that the program is encoded by the two-dimensional code 30, detected by the mobile computer device 16 and shared in a social network via the internet. Furthermore, the user may create a program for performing a treatment by the domestic appliance 10 on the basis of his experience, which program allows a sufficient treatment by the domestic appliance 10 on the one hand and minimizes the energy consumption on the other hand. Such optimized programs may be encoded by the two-dimensional code 30, detected by the mobile computer device 16 and shared in the social network via the internet.

Although an illustrative embodiment of the present invention has been described herein with reference to the accompanying drawing, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 domestic appliance
12 user interface
14 graphic display
16 mobile computer device
18 display
20 camera
22 keyboard
24 wireless data connection
26 internet
30 two-dimensional code

1. Method for performing a treatment by a domestic appliance (10), wherein the domestic appliance (10) includes at least one programmable control unit and at least one graphic display device (14), and wherein the method comprises the steps of:
providing a program for performing the treatment,
executing the program for performing the treatment,
encoding information about the domestic appliance (10), the program for performing the treatment and/or a current status of the domestic appliance (10),
generating a two-dimensional code (30) representing the encoded information about the domestic appliance (10), the program for performing the treatment and/or the current status of the domestic appliance (10), and
displaying said two-dimensional code (30) on the graphic display (14), so that
the two-dimensional code (30) is detectable by a camera (20) or scanner of a mobile computer device (16).

2. Method for processing information about a treatment performed by a domestic appliance (10), wherein said information is encoded by a two-dimensional code (30) indicated by a graphic display (14) of the domestic appliance (10), and wherein the method comprises the steps of:
detecting the two-dimensional code (30) by a camera (20) or scanner of a mobile computer device (16),
decoding the two-dimensional code (30), and
indicating the decoded information on a display (14) of the mobile computer device (16), and/or
transmitting the decoded information to a further computer device via the internet, and/or
processing the decoded information by an application software on the mobile computer device (16) and/or on the further computer device.

3. The method according to claim 1,
characterized in that
the two-dimensional code (30) includes information about at least one fault of the domestic appliance (10), if the control unit of the domestic appliance (10) has detected said at least one fault.

4. The method according to claim 1,
characterized in that
the two-dimensional code (30) includes information about a predetermined number of the last faults of the domestic appliance (10), so that a fault history for the domestic appliance (10) is provided.

5. The method according to claim 1,
characterized in that
the two-dimensional code (30) provides information about the complete operating duration of the domestic appliance (10) since said domestic appliance (10) has been installed.

6. The method according to claim 1,
characterized in that
the two-dimensional code (30) provides information about a link to the homepage of the producer and/or distributor of the domestic appliance (10).

7. The method according to claim 1,
characterized in that
the treatment is a cooking process performed by a cooking appliance (10), wherein a cooking recipe and/or program for the cooking process is encoded by the two-dimensional code (30).

8. The method according to claim 7,
characterized in that
the cooking recipe and/or program for said cooking process is created or creatable by the user.

9. The method according to claim 7,
characterized in that
the cooking recipe and/or program for the cooking process is decoded by the mobile computer device (16) and transmitted to a social network via the internet.

10. The method according to claim 1,
characterized in that
the two-dimensional code (30) includes information for activating the warranty the domestic appliance (10), wherein said information is decoded by the mobile computer device (16) and transmitted to the producer and/or distributor of the domestic appliance (10) via the internet.

11. Application software for a mobile computer device (16) including
a camera (20) or scanner,
characterized in that
the application software is provided for performing a method according to claim 2.

12. Application software according to claim 11,
characterized in that
the application software is provided by the producer and/or distributor of the domestic appliance (10) and downloadable via the internet.

13. Domestic appliance (10) comprising at least one programmable control unit and at least one graphic display (14), wherein the control unit is provided for encoding information about the domestic appliance (10), the program for performing the treatment and/or a current status of the domestic appliance (10), and wherein the graphic display (14) is provided for indicating a two-dimensional code (30) representing said encoded information,
characterized in that
the domestic appliance (10) is provided for a method according to claim 1.

14. Mobile computer device (16) connected or connectable to the internet and including a camera (20) or scanner for detecting and decoding a two-dimensional code (30) indicated by a graphic display (14),
characterized in that
the mobile computer device (16) is provided for a method according to claim 2.

15. Computer program stored in a non-transitory computer readable medium, comprising computer readable program means for causing a computer to perform a method according to claim 1, wherein the computer program includes application software.
